(19) United States
(12) Patent Application Publication
(10) Pub. No.: US 2014/0244521 A1
(43) Pub. Date: Aug. 28, 2014

(54) SYSTEMS AND METHODS FOR LEGAL DATA PROCESSING

(71) Applicant: Datanalytics, Inc. d/b/a Juristat, St. Louis, MO (US)

(72) Inventors: Andrew Winship, St. Louis, MO (US); Robert Ward, St. Louis, MO (US); Jordan Woerndle, St. Louis, MO (US)

(73) Assignee: Datanalytics, Inc. d/b/a Juristat, St. Louis, MO (US)

(21) Appl. No.: 14/192,436

(22) Filed: Feb. 27, 2014

Related U.S. Application Data
(60) Provisional application No. 61/770,260, filed on Feb. 27, 2013.

(51) Int. Cl. G06Q 50/18; G06Q 10/00

(52) U.S. Cl. CPC G06Q 50/18; G06Q 10/00
USPC 705/311

(57) ABSTRACT

Systems and methods for organizing multiple public legal databases of related and unrelated data into a unified structure and deriving data analytics from the unified database. The data and analytics are then provided to attorneys, judges, and other users to assist with litigation and business strategies.

### CROSS REFERENCE TO RELATED APPLICATION(S)

This application claims benefit of U.S. Provisional Patent Application No. 61/770,260 filed Feb. 27, 2013, the entire disclosure of which is incorporated herein by reference.

### BACKGROUND

1. Field of the Invention

Aspects of the present disclosure relate to methods for accessing, retrieving, and/or processing data stored in a computer readable media, and in particular, data related to the legal industry.

2. Description of the Related Art

The legal professional is currently going through a dramatic paradigm shift. Lawyers are desperate to save time, reduce costs, and remain competitive against other firms by providing better results to their clients and out-marketing the competition.

The latter portion of the last century was a Golden Age for the practice of law. In 1978, Americans spent just 0.4% of our GDP on legal services. By 2003, that amount had increased almost 5-fold. Since then, market metrics have stagnated or begun to fall. Some claim this industry-wide tightening is temporary, caused by the 2008 collapse of Lehman Brothers and subsequent recession. However, even a cursory inspection shows that the changes in the legal industry were taking hold long before the market downturn. Law firm employment peaked in 2004, and it has been stagnant or falling since. Today, there are twice as many new law school graduates as positions available. Profits per partner at the nation's top firms have been flat, other than a bump in 2010 that was largely achieved through cost savings from shedding attorneys.

Some of the largest firms in the world have collapsed in the pas few years, including Howrey, Wolf Block, and Dewey & Leboeuf. Howrey's boss, Robert Ruyak, blamed the firm's demise on two trends: (1) clients' increasing demand for alternative fee arrangements and (2) legal technology services taking routine but lucrative document revenue and analysis work previously carried out by young associates. Experts, including Gregory Jordan, managing partner of Reed Smith, one of the 25 largest law firms in the world, agree this “better, faster, cheaper concept is very much here to stay.”

### SUMMARY

Because of these and other problems in the art, described herein, among other things, is a system for providing legal analytics to an attorney comprising: a computer server communicating over a data network, the computer server comprising: a database having one or more datasets comprising legal data and one or more datasets comprising actionable analytics, each one of the one or more analytics being derived at least in part from legal data in at least one of the one or more legal data datasets; a microprocessor; a non-transitory machine-readable storage comprising machine-readable instructions which, when executed by the microprocessor, cause the computer server to provide over the data network, in response to a user request comprising search criteria data, a response datagram comprising response data indicative at least one of the one or more analytics, the at least one of the one or more analytics being selected based at least in part on the search criteria data.

In an embodiment of the system, at least one of the one or more datasets comprising legal data is a publicly available legal data dataset.

In another embodiment of the system, the publicly available legal dataset comprises court data.

In another embodiment of the system, the court data pertains to a state court.

In another embodiment of the system, the court data pertains to a federal court.

Also described herein, among other things, is a method for providing legal data analytics comprising: providing a plurality of at least partially unstructured legal datasets; providing a database; providing a computer server communicating over a data network; structuring each dataset in the plurality of at least partially unstructured legal datasets into one structured legal dataset; storing the structured legal dataset in the database; deriving a plurality of legal data analytics in the structured legal dataset; the computer server receiving over the data network a user request comprising search criteria data; selecting from the structured legal dataset in the database at least some responsive legal data and at least one responsive legal data analytic, the responsive legal data being based at least in part on the search criteria data and comprising at least some data derived from a plurality of datasets in the plurality of at least partially unstructured legal datasets and the responsive data analytic being derived at least in part from the responsive legal data; the computer server responding to the user request with a responsive datagram indicative of the selected responsive legal data and the responsive legal data analytic.

In an embodiment of the method, at least one dataset in the plurality of at least partially unstructured legal datasets comprises court data.

In another embodiment of the method, the court data pertains to a state court.

In another embodiment of the method, the court data pertains to a federal court.

In another embodiment of the method, at least one legal data analytic in the plurality of legal data analytics is indicative of the past behavior of a judge.

In another embodiment of the method, at least one legal data analytic in the plurality of legal data analytics is indicative of the past behavior of an attorney.

In another embodiment of the method, at least one of the at least one responsive legal data analytics is indicative of the past behavior of a judge.

In another embodiment of the method, the past behavior of a judge is a pattern of ruling on a particular type of motion.

In another embodiment of the method, the particular type of motion is selected from the group consisting of a motion to dismiss, a motion for summary judgment, and a motion to certify a class action.

In another embodiment of the method, the responsive datagram further comprises data indicative of a prediction of future behavior of the judge, the prediction being based at least in part upon the responsive legal data analytic indicative of the past behavior of the judge.

In another embodiment of the method, the future behavior of the judge is ruling on a particular type of motion.

In another embodiment of the method, the particular type of motion is selected from the group consisting of a motion to dismiss, a motion for summary judgment, and a motion to certify a class action.

In another embodiment of the method, the prediction is that the judge will grant the motion.

In another embodiment of the method, the prediction is that the judge will issue the ruling on the motion in a particular amount of time.

### BRIEF DESCRIPTION OF THE DRAWINGS

FIG. 1 is a block diagram illustrating a computing network, according to aspects of the present disclosure.

FIG. 2 is an example flow chart for processing legal data, according to aspects of the present disclosure.

FIG. 3 is a block diagram of a computing device, according to aspects of the present disclosure.

### DETAILED DESCRIPTION OF THE PREFERRED EMBODIMENT(S)

The foregoing and other objects, features, and advantages of the present disclosure set forth herein will be apparent from the following description of particular embodiments of those inventive concepts, as illustrated in the accompanying drawings. It should be noted that the drawings are not necessarily to scale; however, the emphasis instead is being placed on illustrating the principles of the inventive concepts. Also, in the drawings the like reference characters refer to the same parts throughout the different views. The drawings depict only typical embodiments of the present disclosure and, therefore, are not to be considered limiting in scope.

Aspects of the present disclosure involve systems and methods for accessing, retrieving, and/or otherwise obtaining data stored in a database, data store and/or other type of storage device. In various aspects, the data may be processed, filtered, clustered, analyzed, compared and/or the like to generate one or more actionable analytical metrics, as explained in “Appendix A”, which is incorporated in its entirety by reference herein. Subsequently, the data and/or the generated analytical metrics may be provided for presentation and/or display.

In one embodiment, aspects of the present disclosure are directly applicable to the legal industry. Accordingly, the data that may be accessed, stored, processed, etc., may be legal data and/or legal information. The analytical metrics, datasets, aggregations, and/or other results generated by the systems and methods described herein may be presented to users in any of a number of useful ways, such as in a report that may be printed or displayed on a computer. Moreover, the system may include user interface tools, such as graphical user interfaces (GUIs) and the like, to help users structure a preferred search, presentation, analysis, and/or the like. The various user-interfaces and/or user-interface tools may be accessed for analysis by lawyers, law firms, and/or various other entities or parties involved in the legal industry.

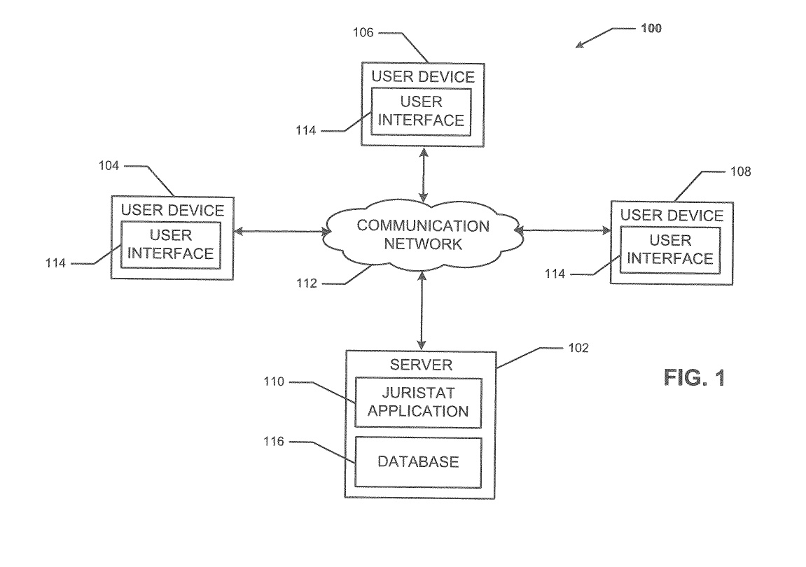

FIG. 1 is an example illustration of a computing environment 100 for accessing, storing, and processing data, and in particular, legal data, according to aspects of the present disclosure. The computing environment 100 includes a server 102, which will involve at least one processor deployed in a personal computer, work station, server, mobile device, mobile phone, tablet device, and/or other processing device, and which may execute a juristat application 110 that processes data, such as legal data, to generate actionable metrics and/or related analytics for presentation to users. The processors of the server 102 include software or other machine-readable instructions, such as the juristat application 110, and may include a memory to store the software or other machine-readable instructions and data. The memory may include volatile and/or non-volatile memory. Additionally, the server 102 may also include a communication system to communicate via a wireline and/or wireless communication, such as through the Internet, an intranet, an Ethernet network, a wireline network, a wireless network, a mobile communications network, and/or other communication network, such as communication network 112.

The server 102 may further include a database(s) 116, which may be a general repository of data including legal data, legal information, actionable analytics and/or metrics, court data, court information, and/or any other information related to or required by the legal industry. The database 116 may include memory and one or more processors or processing systems to receive, process, query, and transmit communications and store and retrieve such data. In another aspect, the database 116 may be a database server. While the database(s) 116 is depicted as being a part of the server 102, it is contemplated that it may be located elsewhere, such as for example, somewhere external to the server 102 and accessible via the communication network 112.

A user, such as a lawyer, law firm, and/or other parties involved in the legal industry, may interact with user devices 104-108 to access the actionable analytics, metrics, and/or other results that may be generated by the juristat application 110 via the communication network 112. The user devices 104-108 may be a personal computer, work station, server, mobile device, mobile phone, tablet device, processor, and/or other processing device. Each device may include one or more processors that process software or other machine-readable instructions and may include a memory to store the software or other machine-readable instructions and data. The memory may include volatile and/or non-volatile memory. Additionally, each device may also include a communication system to communicate via a wireline and/or wireless communication, such as through the Internet, an intranet, an Ethernet network, a wireline network, a wireless network, a mobile communications network, and/or another communication network.

The user devices 104-108 may include a user-interface (UI) 114 for a user to provide input, such as configuration information, for provisioning and/or configuring various aspects of a computing environment as a service. UI 114 may include a display (not shown) such as a computer monitor, liquid crystal display, for viewing data and/or input forms, and any combination of input/output devices (not shown), such as a keyboard or a pointing device (e.g., a mouse, trackball, pen, or touch pad), speaker, and/or any other type of device for receiving input.

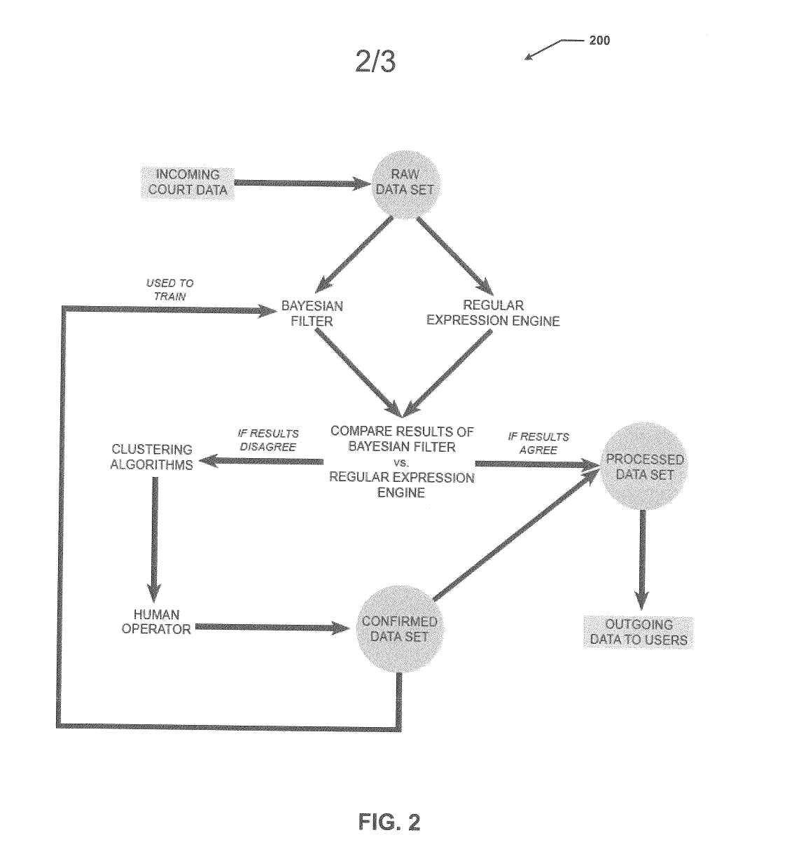

FIG. 2 includes a flowchart according to embodiments herein, which illustrates the functional information one of ordinary skill in the art could use to fabricate circuits or to generate computer software (or a hybrid of both circuits and software code) to carry out the features as described herein. It should be noted that many routine program elements, such as initialization of loops and variables and the use of temporary variables, are inherent in the flowcharts. It will be appreciated by those of ordinary skill in the art that unless otherwise indicated herein, the particular sequence of steps described is illustrative only and can be varied without departing from the spirit of the invention. Thus, unless otherwise stated, the steps described below are unordered, meaning that, when possible, the steps can be performed in any convenient or desirable order.

In particular, FIG. 2 depicts an example embodiment of a method and/or process 200 for processing data, such as legal data, legal information, court data, and/or court information. The process 200, as is explained in “Appendix B”, which is incorporated in its entirety by reference herein, may be executed by at least one processor (e.g., encoded with, or executing instructions of, the juristat application 110) for processing legal data and/or court data to generate various analytical metrics.

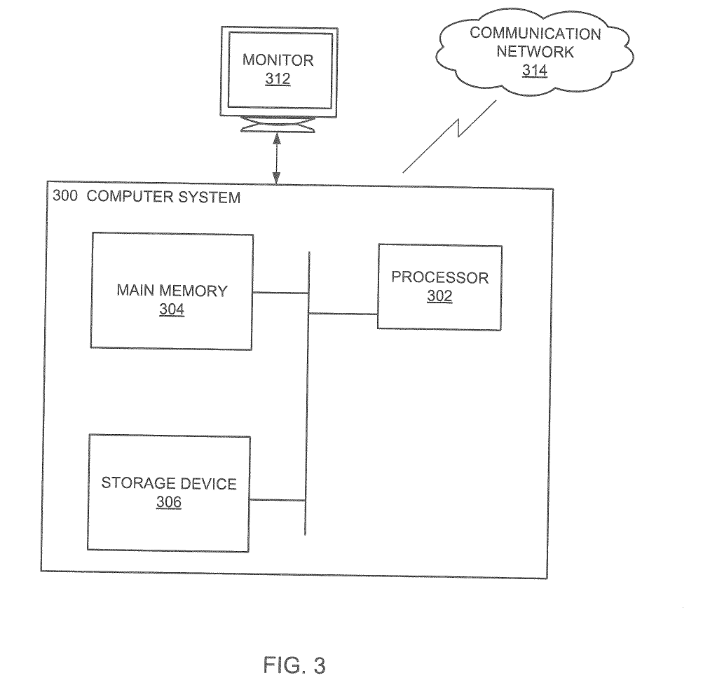

The various inventive concepts described above may be implemented on virtually any type of computer regardless of the platform being used. For example, as shown in FIG. 3, a computer system 300 includes a processor 302, associated memory 304, a storage device 306, and numerous other elements and functionalities typical of today's computers (not shown). The computer system 300 may also include input means, such as a keyboard and a mouse, and output means such as a monitor 312. The computer system 300 may be connected to a local area network (LAN) or a Wide area network (e.g., the Internet), such as communication network 514, via a network interface connection (not shown). Those skilled in the art will appreciate that these input and output means may take other forms.

Further, those skilled in the art will appreciate that one or more elements of the computer system 300 may be located at a remote location and connected to the other elements over a network. The invention may be implemented on a distributed system having a plurality of nodes, where each portion of the invention (e.g., the operating system, file system, cache, application(s), etc.) may be located on a different node within the distributed system, and each node may correspond to a computer system. Alternatively, the node may correspond to a processor with associated physical memory. The node may alternatively correspond to a processor with shared memory and/or resources. Further, software instructions to perform embodiments of the invention may be stored on a tangible computer-readable medium such as a compact disc (CD), a diskette, a tape, a digital versatile disk (DVD), or any other suitable tangible computer-readable storage device.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method presents elements of the various steps in a sample order, and is not necessarily meant to be limited to the specific order or hierarchy presented.

The described disclosure may be provided as a computer program product, or software, that may include a machine-readable medium having stored thereon instructions which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

1. A system for providing legal analytics to an attorney comprising:
a computer server communicating over a data network, said computer server comprising:
a database having one or more datasets comprising legal data and one or more datasets comprising actionable analytics, each one of said one or more analytics being derived at least in part from legal data in at least one of said one or more legal data datasets;
a microprocessor;
a non-transitory machine-readable storage comprising machine-readable instructions which, when executed by said microprocessor, cause said computer server to provide over said data network, in response to a user request comprising search criteria data, a response datagram comprising response data indicative at least one of said one or more analytics, said at least one of said one or more analytics being selected based at least in part on said search criteria data.

2. The system as claimed in claim 1, wherein at least one of said one or more datasets comprising legal data is a publicly available legal data dataset.

3. The system as claimed in claim 2, wherein said publicly available legal dataset comprises court data.

4. The system as claimed in claim 3, wherein said court data pertains to a state court.

5. The system as claimed in claim 3, wherein said court data pertains to a federal court.

6. A method for providing legal data analytics comprising:
providing a plurality of at least partially unstructured legal datasets;
providing a database;
providing a computer server communicating over a data network;
structuring each dataset in said plurality of at least partially unstructured legal datasets into one structured legal dataset;
storing said structured legal dataset in said database;
deriving a plurality of legal data analytics in said structured legal dataset;
said computer server receiving over said data network a user request comprising search criteria data;
selecting from said structured legal dataset in said database at least some responsive legal data and at least one responsive legal data analytic, said responsive legal data being based at least in part on said search criteria data and comprising at least some data derived from a plurality of datasets in said plurality of at least partially unstructured legal datasets and said responsive data analytic being derived at least in part from said responsive legal data;
said computer server responding to said user request with a responsive datagram indicative of said selected responsive legal data and said responsive legal data analytic.

7. The method as claimed in claim 6, wherein at least one dataset in said plurality of at least partially unstructured legal datasets comprises court data.

8. The method as claimed in claim 7, wherein said court data pertains to a state court.

9. The method as claimed in claim 7, wherein said court data pertains to a federal court.

10. The method as claimed in claim 6, wherein at least one legal data analytic in said plurality of legal data analytics is indicative of the past behavior of a judge.

11. The method as claimed in claim 6, wherein at least one legal data analytic in said plurality of legal data analytics is indicative of the past behavior of an attorney.

12. The method as claimed in claim 6, wherein at least one of said at least one responsive legal data analytics is indicative of the past behavior of a judge.

13. The method as claimed in claim 12, wherein said past behavior of a judge is a pattern of ruling on a particular type of motion.

14. The method as claimed in claim 13, wherein said particular type of motion is selected from the group consisting of a motion to dismiss, a motion for summary judgment, and a motion to certify a class action.

15. The method as claimed in claim 12, wherein said responsive datagram further comprises data indicative of a prediction of future behavior of said judge, said prediction being based at least in part upon said responsive legal data analytic indicative of said past behavior of said judge.

16. The method as claimed in claim 15, wherein said future behavior of said judge is ruling on a particular type of motion.

17. The method as claimed in claim 16, wherein said particular type of motion is selected from the group consisting of a motion to dismiss, a motion for summary judgment, and a motion to certify a class action.

18. The method as claimed in claim 16, wherein said prediction is that said judge will grant said motion.

19. The method as claimed in claim 16, wherein said prediction is that said judge will issue said ruling on said motion in a particular amount of time.
